(19) United States
(12) Patent Application Publication
(10) Pub. No.: US 2004/0179431 A1
(43) Pub. Date: Sep. 16, 2004

(54) Sensor device and electronic watch

(76) Inventor: Kenichi Nakajima, Chiba-shi (JP)

Correspondence Address: ADAMS & WILKS, 31st Floor, 50 Broadway, New York, NY, 10004, US

(21) Appl. No.: 10/775,701

(22) Filed: Feb. 10, 2004

(30) Foreign Application Priority Data
Feb. 25, 2003 (JP) 2003-047248

(51) Int. Cl. G04B 47/06

(52) U.S. Cl. 368/11

(57) ABSTRACT

To make it possible to detect that a detection object reaches a position at a predetermined distance. A sensor and a sensor are located on a substrate. The sensors each include a pyroelectric infrared sensor element and a cover member that has a through hole and covers the sensor element. The sensor elements each are constructed such that the detection object can be detected only through the through hole, so that the sensor have the same predetermined directivity. The sensors are located such that detection areas of the respective sensors cross each other. Each of the sensors detects an infrared ray having a frequency emitted from a skin of a human and outputs a detection signal. When the detection object reaches the intersection of the detection areas of the sensors, the detection signals are simultaneously obtained from both the sensors.

### BACKGROUND OF THE INVENTION

1. Field of the Invention

The present invention relates to a sensor device for detecting a detection object such as a person and an electronic watch using the sensor device.

2. Description of the Prior Art

Up to now, with respect to an electronic watch that operates using a battery as a power source, there have been utilized various electronic watches such as a digital display type electronic wrist watch in which a display unit having large display power is mounted, a digital display type electronic wrist watch in which a backlight having large power consumption and the like are mounted, and an analog display type electronic wrist watch whose hands are rotated by motors.

In the case of the electronic wrist watch in which the display unit having large display power is mounted or the electronic wrist watch in which the backlight having large power consumption and the like are mounted, when display or backlight illumination is continuously performed, the power consumption is significant. Therefore, there is a problem in that a battery life becomes extremely short. In addition, even in the case of the analog display type electronic wrist watch, when display hands are continuously rotated by the motors, the power consumption is significant. Therefore, there is a problem in that a battery life becomes extremely short.

In order to solve the problem, there has been developed an electronic wrist watch which is constructed such that display on the display unit, backlight illumination, or the like is performed by user's manual operation of an external operation member when necessary. Therefore, because the display, the backlight illumination, or the like is performed only when the external operation member is manually operated by the user, the power consumption can be reduced, so that the battery life can be lengthened.

However, the manual operation of the external operation member is complicated in the above-mentioned electronic watch. Therefore, there has been developed an electronic wrist watch which is constructed so as to indirectly detect whether or not a user looks at the watch by a sensor device having a structure shown in FIG. 10 and to perform display or backlight illumination only when it is detected.

In FIG. 10, a substrate 1001 and a pyroelectric infrared sensor 102 which is located on the substrate 1001 and that detects an infrared ray emitted from a person are located in the electronic wrist watch. In addition, the pyroelectric infrared sensor 102 is located such that an infrared ray emitted from a user of the electronic wrist watch can be detected.

When the user reaches a position in which he/she looks at the electronic watch, that is, when the sensor 1002 and the face of the user are relatively within a predetermined distance, the sensor 1002 detects the infrared ray emitted from the user and the drive of a display device or the backlight illumination is performed by control means. Thus, the power consumption can be automatically reduced, so that the battery life can be lengthened.

Now, for example, as described in JP 59-024228 A (pages 1 and 2 and FIG. 1) and JP 60-151576 A (pages 2 and 3 and FIG. 3), a detection object that exists nearer than a predetermined distance can be detected by a conventional sensor device using the pyroelectric infrared sensor 1002. However, it has no directivity and is constructed so as to detect all detectable objects that exist in a hemispherical area about the sensor 1002. Therefore, there is a problem in that even an unnecessary object is detected in error. As a possible method of solving the problem, there is a structure having directivity using a concave mirror or the like.

However, in this method, there is a problem in that only whether or not the detection object exists within a predetermined distance can be detected.

Also, in the case where the sensor device is used for the electronic watch to display a time or the like when the user looks at the watch, there is a problem in that detection accuracy as to whether or not the user looks at the watch is low.

An object of the present invention is to provide a sensor device capable of detecting whether or not a detection object reaches a position at a predetermined distance.

Another object of the present invention is to provide a sensor device capable of detecting a moving direction of a detection object.

Further another object of the present invention is to provide an electronic watch in which whether or not the user looks at the watch can be detected with higher accuracy and a time or the like can be displayed when the user looks at the watch.

### SUMMARY OF THE INVENTION

According to the present invention, there is provided a sensor device which is characterized by including a plurality of strong directive sensors each having a predetermined directivity and in that the plurality of sensors are located such that detection areas thereof cross each other. When a detection object reaches a position in which the detection areas of the plurality of strong directive sensors cross each other, the respective sensors simultaneously detect the detection object.

Here, it may be constructed so as to include position determining means for determining that the detection object reaches a predetermined position based on a detection signal indicating that the detection object is detected, which is received from each of the sensors.

Also, the sensor device further includes a weak directive sensor having a directivity weaker than the plurality of strong directive sensors and may be constructed such that the position determining means receives the detection signal indicating that the detection object is detected from each of the strong directive sensors after it receives the detection signal indicating that the detection object is detected from the weak directive sensor and thus determines that the detection object reaches the predetermined position.

Also, it may be constructed so as to include moving direction determining means for determining a moving direction of the detection object based on an order in which the respective strong directive sensors detect the detection object.

Also, the sensor device further includes a weak directive sensor having a directivity weaker than the plurality of strong directive sensors and may be constructed such that the moving direction determining means determines the moving direction of the detection object based on the order in which the respective strong directive sensors detect the detection object after the detection signal indicating that the detection object is detected is received from the weak directive sensor.

Also, it may be constructed such that each of the sensors is a pyroelectric infrared sensor that detects an infrared ray emitted from a person.

Also, according to the present invention, there is provided an electronic watch having display means for displaying a time and drive means for driving the display means, which is characterized by including the pyroelectric infrared sensor device and in that the drive means drives the display means when the position determining means of the sensor device determines that a user is in a predetermined position or when the moving direction determining means determines that the moving direction of the user is a predetermined direction. When the position determining means determines that the user is in the predetermined position or when the moving direction determining means determines that the moving direction of the user is the predetermined direction, the drive means drives the display means.

### BRIEF DESCRIPTION OF THE SEVERAL VIEWS OF THE DRAWINGS

A preferred form of the present invention is illustrated in the accompanying drawings in which:

FIG. 1 is an external front view of an electronic watch according to a first embodiment mode of the present invention;

FIG. 2 is a block diagram of the electronic watch according to the first embodiment mode of the present invention;

FIG. 3 is a side view showing details of a sensor device according to the first embodiment mode of the present invention;

FIG. 4 is a flow chart showing processing of the electronic watch according to the first embodiment mode of the present invention;

FIG. 5 are explanatory views for explaining operation of the electronic wrist watch according to the first embodiment mode of the present invention;

FIG. 6 is an external front view of an electronic watch according to a second embodiment mode of the present invention;

FIG. 7 is a block diagram of the electronic watch according to the second embodiment mode of the present invention;

FIG. 8 is a side view showing details of a sensor device according to the second embodiment mode of the present invention;

FIG. 9 is a flow chart showing processing of the electronic watch according to the second embodiment mode of the present invention; and

FIG. 10 is a side view showing a conventional sensor device.

### DETAILED DESCRIPTION OF THE PREFERRED EMBODIMENTS

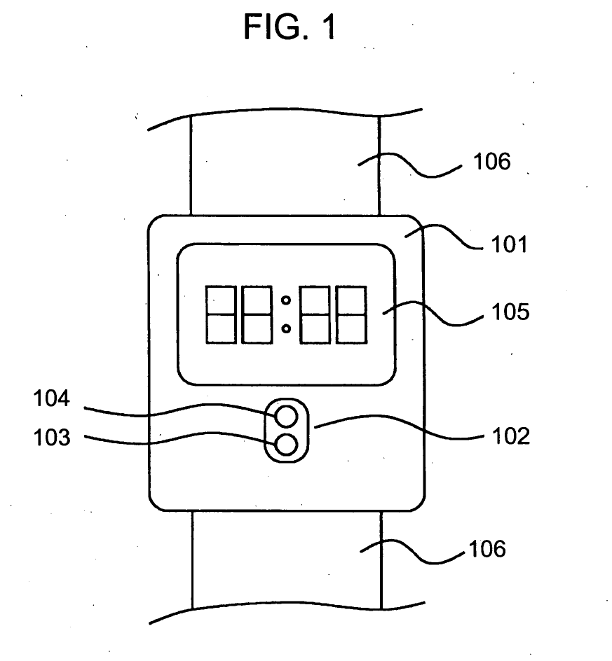

FIG. 1 is an external front view of an electronic watch according to a first embodiment mode of the present invention, which shows an example of an electronic wrist watch that operates using a battery as a power source.

In FIG. 1, the electronic wrist watch includes a case main body 101 made of an infrared shielding member, a sensor section 102 stored in the case main body 101 through a window portion that transmits an infrared ray having a frequency emitted from at least a human body, a display section 105 serving as a section to be controlled, and bands 106 and 106. The sensor section 102 has a plurality of sensors composed of pyroelectric infrared sensors (first sensor 103 and second sensor 104). The display section 105 is composed of a liquid crystal display (LCD) having a backlight and is a digital display device that digitally displays a time or the like.

Note that the electronic wrist watch includes watch movements and a battery for supplying drive power to the backlight of the display section 105 and the like, which are received in the case main body 101.

FIG. 3 is a side view showing details of the sensor section 102 serving as the sensor device according to the first embodiment mode of the present invention, in which the same reference numerals are provided to the same portions as in FIG. 1.

In FIG. 3, the sensor 103 and the sensor 104 are located on a substrate 301 received in the case main body 101. The sensor 103 includes a pyroelectric infrared sensor element 302 and a cover member 303 that has a through hole 304 and covers the sensor element 302. The sensor element 302 is constructed such that a detection object can be detected only through the through hole 304. Therefore, the sensor 103 has a narrow directivity of a predetermined range (strong directivity).

Similarly, the sensor 104 includes a pyroelectric infrared sensor element 305 and a cover member 307 that has a through hole 306 and covers the sensor element 305. The sensor element 305 is constructed such that the detection object can be detected only through the through hole 307. Therefore, a directivity of a predetermined range is provided to the sensor 104. In the first embodiment mode of the present invention, the sensor 103 and the sensor 104 each have the strong directivity of the same range in which a detection area is narrow.

The sensors 103 and 104 are located such that the detection areas of the respective sensors 103 and 104 cross each other. Each of the sensors 103 and 104 is constructed so as to detect an infrared ray having a frequency emitted from the skin of a human being and to output a detection signal. Therefore, when the detection object (for example, the face of the user of the electronic wrist watch) reaches the intersection of the detection areas of the sensors 103 and 104, the detection signals are simultaneously obtained from both the sensors 103 and 104.

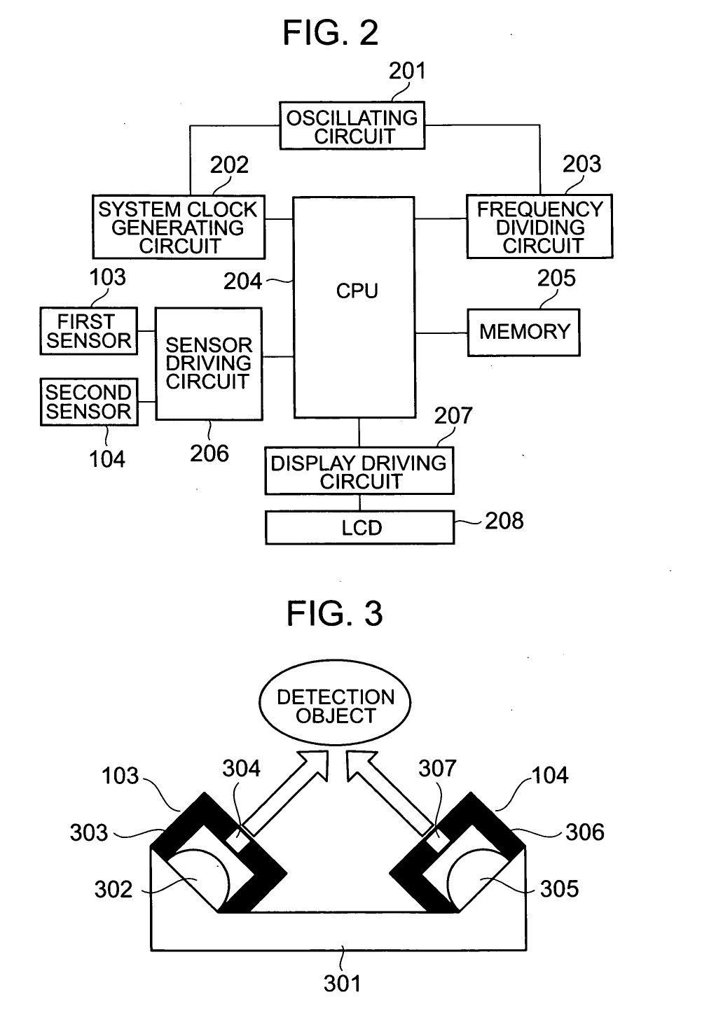

FIG. 2 is a block diagram of the electronic watch according to the first embodiment mode of the present invention, which shows an example of the electronic wrist watch that operates using the battery as the power source. The same reference numerals are provided to the same portions as in FIGS. 1 and 3.

In FIG. 2, the electronic wrist watch includes: an oscillating circuit 201 that generates a reference clock signal; a system clock generating circuit 202 that generates a system clock signal in accordance with the reference clock signal; a frequency dividing circuit 203 that frequency-divides the reference clock signal and generates a clocking reference signal for clocking; a central processing unit (CPU) 204 that performs the clocking operation of the clocking reference signal and the control of the entire electronic wrist watch; a memory 205 which is composed of a read only memory (ROM) and a random access memory (RAM); the sensors 103 and 104; a sensor driving circuit 206 that supplies drive power to the sensors 103 and 104 and outputs to the CPU 204 a detection signal indicating that the sensors 103 and 104 detect the existence of a person when the detection signals from the sensors 103 and 104 are equal to or larger than a predetermined level; a display section 208 composed of a liquid crystal display (LCD); and a display driving circuit 207 that performs the display control of the display section 208 in accordance with a control signal from the CPU 204.

Programs to be executed by the CPU 204, a processing standby (wait) time as described later, and the like are stored in advance in the memory 205.

Note that the display section 208 composes a section to be controlled. The memory 205 composes storage means. The sensor driving circuit 206 composes detection means for receiving the detection signal equal to or larger than the reference signal from the pyroelectric infrared sensors 103 and 104 and outputting a human body detection signal indicating that the pyroelectric infrared sensors 103 and 104 detect the existence of a person. The CPU 204 composes position determining means and moving direction determining means. The CPU 204 and the display driving circuit 207 composes control means.

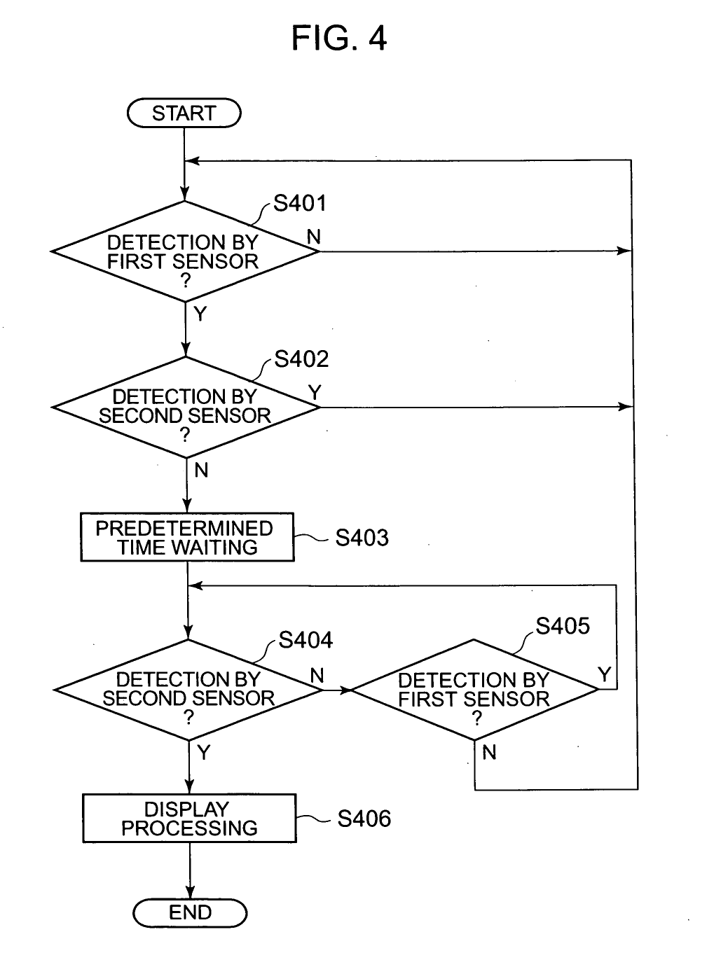

FIG. 4 is a flow chart showing the processing of the electronic wrist watch according to the first embodiment mode of the present invention.

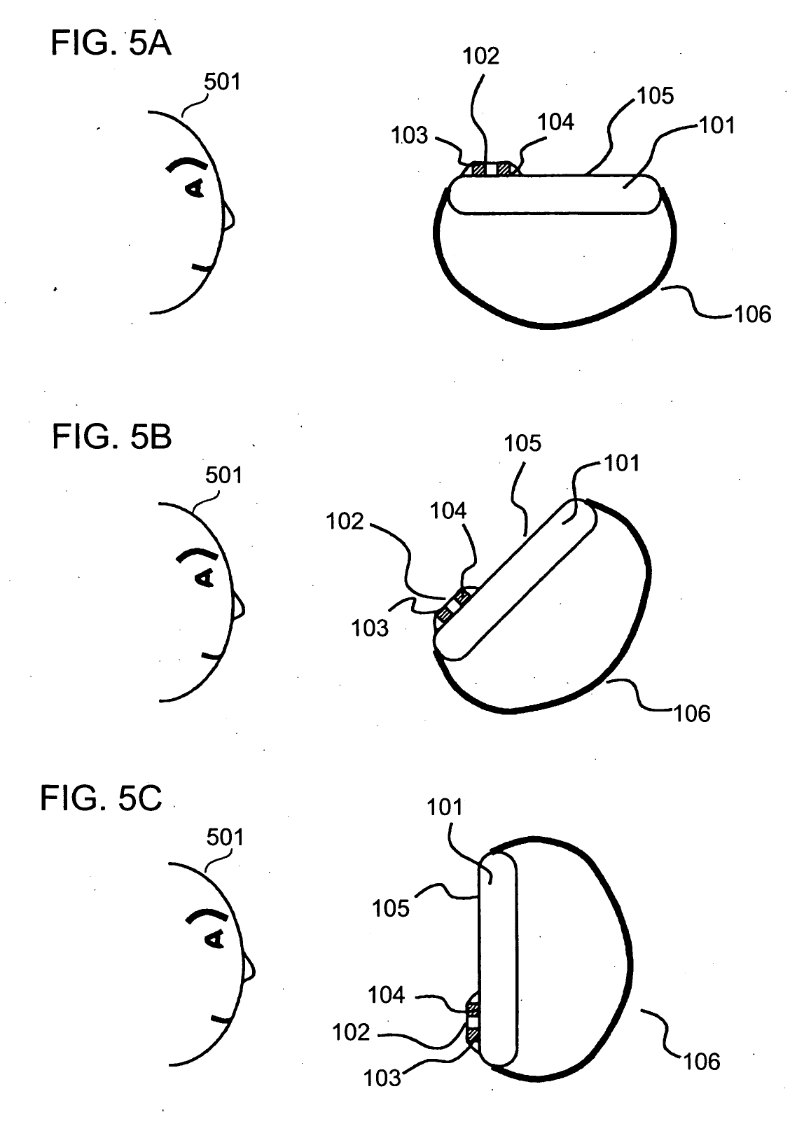

Also, FIG. 5 are explanatory views for explaining the operation of the electronic wrist watch according to the first embodiment mode of the present invention, which shows a relative positional relationship between a user (person) 501 of the electronic wrist watch and the sensor section 102 when the user 501 sees the time on the electronic wrist watch. The same reference numerals are provided to the same portions as in FIGS. 1 to 4.

Note that FIG. 5A shows a state in which the person 501 does not check the time (non-check state), and shows a state in which a tilt angle of the case main body 101 relative to the person 501 is a first tilt angle (for example, 0 degrees) and a positional relationship in which any of the sensors 103 and 104 cannot detect the person 501 is involved. FIG. 5B shows a state in which the person 501 is turning the display section 105 of the wrist watch toward the person in order to check the time, and shows a state (check shift state) in which the tilt angle of the case main body 101 relative to the person 501 is a second tilt angle (for example, 45 degrees) and a positional relationship in which only the sensor 103 can detect the person 501 is involved. In addition, FIG. 5C shows a state in which the person 501 has turned the display section 105 of the wrist watch toward the person in order to check the time, and shows a state (checkable state) in which the tilt angle of the case main body 101 relative to the person 501 is a third tilt angle (for example, 90 degrees) and a positional relationship in which any of the sensors 103 and 104 can detect the person 501 is involved.

Hereinafter, the operation in the embodiment mode of the present invention will be described in detail with reference to FIGS. 1 to 5. In an initial state, assume that the user 501 and the wrist watch are in the non-check state shown in FIG. 5A.

In this state, the frequency dividing circuit 203 frequency-divides the reference clock signal outputted from the oscillating circuit 201 and outputs the clocking reference signal serving as a reference signal for clocking. Also, the system clock generating circuit 202 generates the system clock signal in accordance with the reference clock signal. The CPU 204 operates in accordance with the system clock signal, counts the clocking reference signal, and generates time data indicating the time. The time data is stored in the memory 205 as needed. In addition, the CPU 204 outputs the time data stored in the memory 205 to the display driving circuit 207. However, because both the sensor 103 and the sensor 104 do not detect the person 501 in the non-check state shown in FIG. 5A (see Step S401 in FIG. 4), the CPU 204 does not cause the display driving circuit 207 to drive, so that the time or the like is not displayed on the display section 208.

When the user 501 rotates the user's arm from this state so that the display section 105 of the electronic wrist watch is rotated to the user's side to become the check shift state shown in FIG. 5B, the first sensor 103 detects the user 501 and outputs the detection signal. The CPU 204 receives the detection signal from the sensor 103 through the sensor driving circuit 206, so that it determines that the sensor 103 detects the user 501 (Step S401), and then determines whether or not the second sensor 104 detects the user 501 (Step S402).

When the CPU 204 determines that the second sensor 104 has already detected the user 501 in Step S402, it means that both the sensors 103 and 104 simultaneously detect the person, and such a state is different from the time check shift state. That is, the CPU 204 determines that the user is not making a motion of checking the time and the processing returns to Step S401.

On the other hand, when the CPU 204 determines that the second sensor 104 has not yet detected the user 501 in Step S402, after waiting for a predetermined waiting time set in advance in the memory 205 (Step S403), the CPU determines again whether or not the second sensor 104 detects the user 501 (Step S404). The waiting time is set to a period for which the check shift state shown in FIG. 5B is shifted to the checkable state shown in FIG. 5C (for example, 1 msec. to 50 msec.) by the user in a general use state.

When the CPU 204 determines that the second sensor 104 detects the existence of the user 501 in Step S404, it determines that the user is making a motion of checking the time and outputs the time data indicating the current time stored in the memory 205 to the display driving circuit 207 to perform display processing (Step S406). The display driving circuit 207 drives the display section 208 in response to the time data. The display section 208 displays the current time.

On the other hand, when the CPU 204 determines that the second sensor 104 has not yet detected the existence of the user 501 in Step S404, it determines whether or not the first sensor 103 is still detecting the existence of the user 501 (Step S405).

When the CPU 204 determines that the first sensor 103 is continuously detecting the existence of the user 501 in Step S405, it determines that the user is in the check shift state and the processing returns to the Step S404. When the CPU 204 determines that the first sensor 103 does not detect the user 501, it determines that the user is not in the check shift state and will not check the time and the processing returns to Step S401.

As described above, the sensor device according to the first embodiment mode of the present invention is characterized by including the plurality of strong directive pyroelectric infrared sensors 103 and 104 each having the predetermined directivity and in that the plurality of pyroelectric infrared sensors 103 and 104 are located such that the detection areas thereof cross each other.

Therefore, it is possible to detect whether or not the detection object (user 501) reaches an area at a predetermined distance in which the detection area of the pyroelectric infrared sensor 103 and the detection area of the pyroelectric infrared sensor 104 cross.

Also, the pyroelectric infrared sensor 104 can detect the detection object (user 501) after the pyroelectric infrared sensor 103 detects the detection object (user 501). That is, it is possible to detect the moving direction of the detection object (user 501) which is a change in relative positional relationship between the pyroelectric infrared sensors 103 and 104 and the detection object (user 501). Here, Step S401 to Step S405 compose moving direction determining means.

Also, it is possible to determine that the detection object (user 501) reaches a predetermined position when the pyroelectric infrared sensor 103 and the pyroelectric infrared sensor 104 simultaneously detect the detection object (user 501). Here, Step S401 to Step S405 compose position determining means.

Therefore, when the relative moving direction between the electronic watch and the detection object (user 501) is detected or when the relative positional relationship between the electronic watch and the detection object (user 501) is detected, it is possible to suitably determine whether or not the electronic wrist watch is in a normal use state.

Thus, according to the electronic watch in the first embodiment mode of the present invention, whether or not the user 501 looks at the display section of the electronic wrist watch can be detected with higher accuracy and the time or the like can be displayed when the user 501 looks at the display section of the watch.

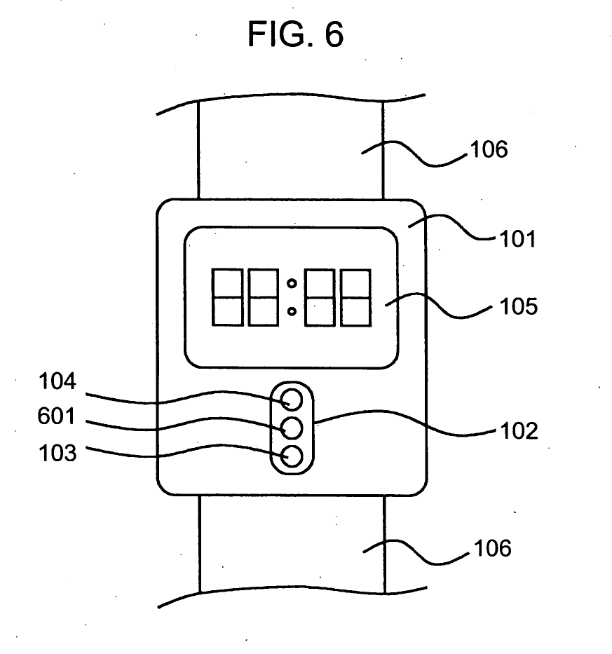

FIG. 6 is an external front view of an electronic watch according to a second embodiment mode of the present invention, which shows an example of an electronic wrist watch that operates using a battery as a power source. The same reference numerals are provided to the same portions as in FIGS. 1 to 5.

In FIG. 6, the electronic wrist watch includes the case main body 101 made of an infrared shielding member, the sensor section 102 stored in the case main body 101 through the window portion that transmits an infrared ray having a frequency emitted from at least a human body, the display section 105 serving as the section to be controlled, and the bands 106, 106. The sensor section 102 has a plurality of sensors composed of pyroelectric infrared sensors (first sensor 103, second sensor 104, and third sensor 601). The display section 105 is composed of the liquid crystal display (LCD) having the backlight and is the digital display device that digitally displays a time or the like.

Note that, with respect to the electronic wrist watch, the watch movements and the battery for supplying drive power to the backlight of the display section 105 and the like are stored in the case main body 101.

FIG. 8 is a side view showing details of the sensor section 102 serving as the sensor device according to the second embodiment mode of the present invention, in which the same reference numerals are provided to the same portions as in FIGS. 1 to 7.

In FIG. 8, the sensor 103, the sensor 104, and the sensor 601 are located on the substrate 301 stored in the case main body 101. The sensor 103 includes the pyroelectric infrared sensor element 302 and the cover member 303 that has the through hole 304 and covers the sensor element 302. The sensor element 302 is constructed such that the detection object can be detected only through the through hole 304. Therefore, the sensor 103 has the directivity of the narrow predetermined range (strong directivity).

Similarly, the sensor 104 includes the pyroelectric infrared sensor element 305 and the cover member 307 that has the through hole 306 and covers the sensor element 305. The sensor element 305 is constructed such that the detection object can be detected only through the through hole 307. Therefore, the directivity of the predetermined range is provided to the sensor 104. In the first embodiment mode of the present invention, the sensor 103 and the sensor 104 each have the strong directivity of the same range in which the detection area is narrow.

The sensor 103 and the sensor 104 are located such that the detection areas of the respective sensors 103 and 104 cross each other.

On the other hand, the sensor 601 includes a pyroelectric infrared sensor element 801 and a cover member 802 that has a through hole 803 and covers the sensor element 801. The sensor element 801 is constructed such that the detection object can be detected only through the through hole 803. Therefore, a directivity of a predetermined range is provided to the sensor 601. In the second embodiment mode of the present invention, the sensor 601 has a directivity of a detection area wider than the sensor 103 and the sensor 104, that is, a directivity weaker than the sensor 103 and the sensor 104.

Each of the sensors 103, 104, and 601 is constructed so as to detect the infrared ray having the frequency emitted from the skin of a human and to output the detection signal. Therefore, when the detection object (for example, the face of the user of the electronic wrist watch) reaches the intersection of the detection areas of the sensors 103, 104, and 601, the detection signals are simultaneously obtained from all the sensors 103, 104, and 601.

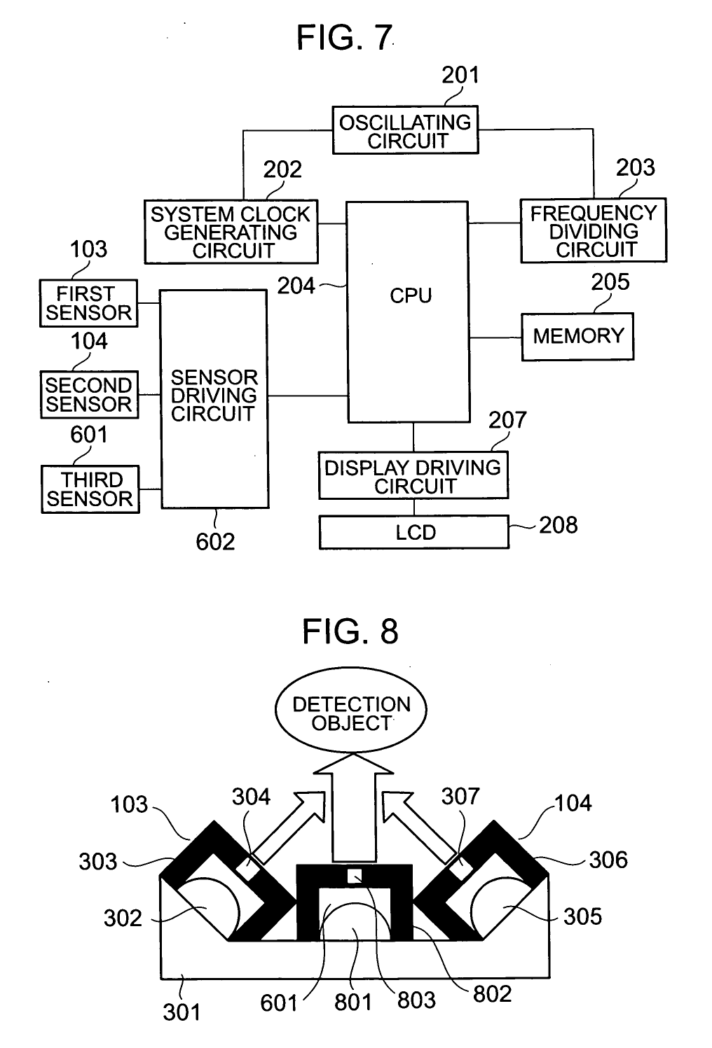

FIG. 7 is a block diagram of the electronic watch according to the second embodiment mode of the present invention, which shows an example of the electronic wrist watch that operates using the battery as the power source. The same reference numerals are provided to the same portions as in FIGS. 1 to 6 and 8.

In FIG. 7, the electronic wrist watch includes: an oscillating circuit 201 that generates the reference clock signal; the system clock generating circuit 202 that generates the system clock signal in accordance with the reference clock signal; the frequency dividing circuit 203 that frequency-divides the reference clock signal and generates the clocking reference signal for clocking; the central processing unit (CPU) 204 that performs the clocking operation of the clocking reference signal and the control of the entire electronic wrist watch; the memory 205 which is composed of the read only memory (ROM) and the random access memory (RAM); the sensors 103, 104, and 601; the sensor driving circuit 206 that supplies drive power to the sensors 103, 104, and 601 and outputs to the CPU 204 a detection signal indicating that the sensors 103, 104, and 601 detect the existence of a person when the detection signals from the sensors 103, 104, and 601 are equal to or larger than a predetermined level; the display section 208 composed of the liquid crystal display (LCD); and a display driving circuit 207 that performs the display control of the display section 208 in accordance with the control signal from the CPU 204.

The memory 205 stores in advance programs to be executed by the CPU 204, the processing standby (wait) time as described later, and the like.

Note that the display section 208 composes the section to be controlled. The memory 205 composes the storage means. The sensor driving circuit 602 composes the detection means for receiving the detection signal equal to or larger than the reference signal from the pyroelectric infrared sensors 103, 104 and 601 and outputting the human body detection signal indicating that the pyroelectric infrared sensors 103, 104 and 601 detect the existence of a person. The CPU 204 composes the position determining means and the moving direction determining means. The CPU 204 and the display driving circuit 207 composes the control means.

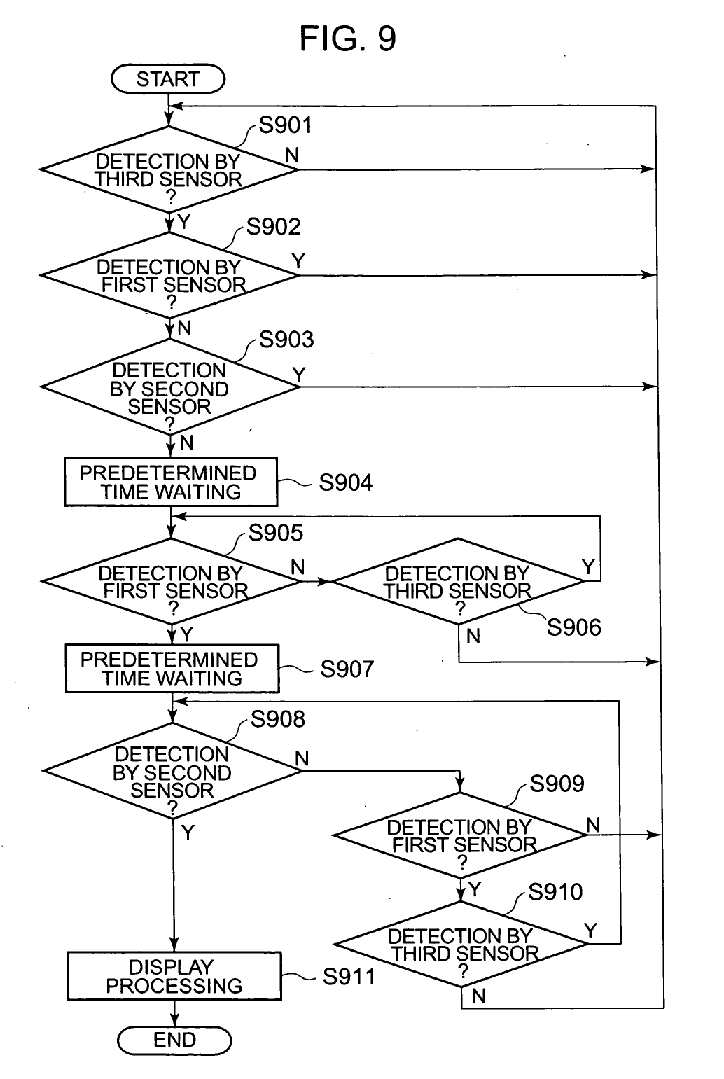

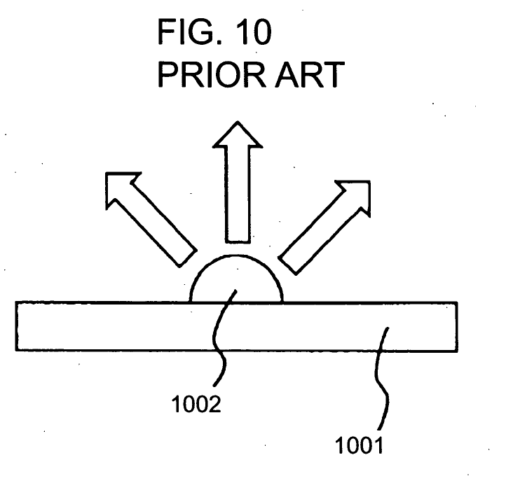

FIG. 9 is a flow chart showing the processing of the electronic wrist watch according to the second embodiment mode of the present invention.

Hereinafter, the operation in the embodiment mode of the present invention will be described in detail with reference to FIGS. 6 to 9. Note that the positional relationship between the electronic watch and the user in the second embodiment mode is the same as in FIG. 5 other than the positional relationship among the sensors 103, 104 and 601. Therefore, the operation will be described with reference to FIG. 5.

In an initial state, assume that the user 501 and the wrist watch are in the non-check state as in FIG. 5A.

With this state, the frequency dividing circuit 203 frequency-divides the reference clock signal outputted from the oscillating circuit 201 and outputs the clocking reference signal serving as the reference signal for clocking. In addition, the system clock generating circuit 202 generates the system clock signal in accordance with the reference clock signal.

The CPU 204 operates in accordance with the system clock signal, counts the clocking reference signal, and generates time data indicating the time. The time data is stored in the memory 205 at any time. In addition, the CPU 204 outputs the time data stored in the memory 205 to the display driving circuit 207. However, because any of the sensors 103, 104, and 601 do not detect the person 501 in the non-check state (see Step S901 in FIG. 9), the CPU 204 does not cause the display driving circuit 207 to drive, so that the time or the like is not displayed on the display section 208.

When the electronic wrist watch is approached to the face of the user 501 from this state in order to check the time, first, the third sensor 601 having the weak directivity detects the user 501 and outputs the detection signal.

The CPU 204 receives the detection signal from the third sensor 601 through the sensor driving circuit 602, so that it determines that the sensor 601 detects the user 501 (Step S901), and then determines whether or not the first sensor 103 detects the user 501 (Step S902).

When the CPU 204 determines that the first sensor 103 has already detected the user 501 in Step S902, it means that both the sensors 601 and 103 simultaneously detect the person, and such a state is different from the time check shift state. That is, the CPU 204 determines that the user is not making a motion of checking the time and the processing returns to Step S901.

When the CPU 204 determines that the first sensor 103 does not detect the user 501 in Step S902, it determines whether or not the second sensor 104 detects the user 501 (Step S903).

When the CPU 204 determines that the second sensor 104 has already detected the user 501 in Step S903, it means that both the sensors 601 and 104 simultaneously detect the person, and such a state is different from the time check shift state. That is, the CPU 204 determines that the user is not making a motion of checking the time and the processing returns to Step S901.

When the CPU 204 determines that the second sensor 104 does not detect the user 501 in Step S903, after waiting for a first predetermined waiting time set in advance in the memory 205 (Step S904), the CPU determines again whether or not the first sensor 103 detects the user 501 (Step S905). The first waiting time is set to a period for which the user is in the check shift state (for example, 1 msec. to 50 msec.) in a general use state.

When the CPU 204 determines that the first sensor 103 detect the user 501 in Step S905, after waiting for a second predetermined waiting time set in advance in the memory 205 (Step S907), the CPU determines again whether or not the second sensor 104 detects the user 501 (Step S908). The second waiting time is a general period necessary to check the time by the user 501 and set to a period from the check shift state to a check completion state (for example, 1 msec. to 50 msec.)

On the other hand, when the CPU 204 determines that the first sensor 103 does not detect the existence of the user 501 in Step S905, it determines whether or not the third sensor 601 is still detecting the existence of the user 501 (Step S906).

When the CPU 204 determines that the third sensor 601 is continuously detecting the user 501 in Step S906, it determines that the user is in the check shift state and the processing returns to Step S905. When the CPU 204 determines that the first sensor 103 does not detect the user 501, it determines that the user is not in the check shift state and will not check the time and the processing returns to Step S901.

When the CPU 204 determines that the second sensor 104 detects the existence of the user 501 in Step S908, it determines that the user is making a motion of checking the time and outputs the time data indicating the current time stored in the memory 205 to the display driving circuit 207 to perform display processing (Step S911). The display driving circuit 207 drives the display section 208 in response to the time data. The display section 208 displays the current time.

On the other hand, when the CPU 204 determines that the second sensor 104 has not yet detected the existence of the user 501 in Step S908, it determines whether or not the first sensor 103 is still detecting the existence of the user 501 (Step S909).

When the CPU 204 determines that the first sensor 103 is continuously detecting the user 501 in Step S909, it determines that the user is in the check shift state and next determines whether or not the third sensor 601 is still detecting the user 501 (Step S910). When it is judged in Step S910 that the third sensor is continuously detecting the user 501, the check shift state is determined and the processing returns to Step S908. When it is judged that the third sensor 601 does not detect the user 501, the CPU determines that the user is not in the check shift state and the processing returns to Step S901.

Also, when the CPU 204 determines that the first sensor 103 does not detect the user 501 in Step S909, it determines that the user is not in the check shift state and is not making a motion of checking the time and the processing returns to Step S901.

Note that Step S901 to Step S910 compose the moving direction determining means and the position determining means.

As described above, according to the sensor device in the second embodiment mode of the present invention, the sensor device includes particularly the sensor 601 having the weak directivity which is a directivity weaker than the other sensors 103 and 104, and the detection signal indicating that the detection object (user 501) is detected is received from each of the sensors 103 and 104 having the strong directivity after the detection signal indicating that the detection object (user 501) is detected is received from the sensor 601, so that it is determined that the detection object (user 501) reaches a predetermined position. Therefore, an effect in which whether or not the user 501 looks at the display section of the electronic wrist watch can be detected with higher accuracy is obtained in addition to the same effect as the first embodiment mode. Thus, in the case where the sensor device is used to control the display section of the electronic watch, the time or the like can be displayed when the user 501 looks at the display section of the watch.

Note that, the example in which the section to be controlled when the pyroelectric infrared sensors detect the person is the display section 105 composed of the liquid crystal display is described in each of the embodiment modes. The section to be controlled may be a backlight of a display device or a drive motor for a time hand or the like in an analog electronic watch.

According to the sensor device in the present invention, it is possible to detect that the detection object is in a position at a predetermined distance.

Also, according to the sensor device in the present invention, it is possible to detect the moving direction of the detection object.

Also, according to the electronic watch in the present invention, whether or not the user looks at the watch can be detected with higher accuracy and the time or the like can be displayed when the user looks at the watch. Thus, the power consumption can be more reliably reduced.

What is claimed is:

1. A sensor device comprising:
a plurality of strong directive sensors each having a predetermined directivity;
wherein the plurality of sensors are located such that detection areas thereof cross each other.

2. A sensor device according to claim 1, further comprising:
a position determining circuit for determining that the detection object reaches a predetermined position based on a detection signal indicating that the detection object is detected, which is received from each of the sensors.

3. A sensor device according to claim 2, further comprising:
a weak directive sensor having a directivity weaker than the plurality of strong directive sensors;
wherein the position determining circuit receives the detection signal indicating that the detection object is detected from each of the strong directive sensors after receiving the detection signal indicating that the detection object is detected from the weak directive sensor, to thereby determining that the detection object reaches the predetermined position.

4. A sensor device according to claim 1, further comprising:
a moving direction determining circuit for determining a moving direction of the detection object based on an order in which the respective strong directive sensors detect the detection object.

5. A sensor device according to claim 4, further comprising:
a weak directive sensor having a directivity weaker than the plurality of strong directive sensors;
wherein the moving direction determining circuit determines the moving direction of the detection object based on the order in which the respective strong directive sensors detect the detection object after the detection signal indicating that the detection object is detected is received from the weak directive sensor.

6. A sensor device according to claim 2, wherein each of the sensors is a pyroelectric infrared sensor that detects an infrared ray emitted from a person.

7. A sensor device according to claim 4, wherein each of the sensors is a pyroelectric infrared sensor that detects an infrared ray emitted from a person.

8. An electronic watch having a display for displaying a time and a drive circuit for driving the display comprising:
the sensor device as described in claim 6,
wherein the drive circuit drives the display when the position determining circuit of the sensor device determines that a user is in a predetermined position or when the moving direction determining circuit determines that the moving direction of the user is a predetermined direction.

9. An electronic watch having a display for displaying a time and a drive circuit for driving the display, characterized by comprising the sensor device as described in claim 7,
wherein the drive circuit drives the display circuit when the position determining circuit of the sensor device determines that a user is in a predetermined position or when the moving direction determining circuit determines that the moving direction of the user is a predetermined direction.
